(19) United States
(12) Patent Application Publication
(10) Pub. No.: US 2007/0127259 A1
(43) Pub. Date: Jun. 7, 2007

(54) Rotary structure

(76) Inventor: Cheng-Chen Lin, Taipei Hsien (TW)

Correspondence Address: BACON & THOMAS, PLLC, 625 SLATERS LANE, FOURTH FLOOR, ALEXANDRIA, VA, 22314, US

(21) Appl. No.: 11/291,786

(22) Filed: Dec. 2, 2005

(51) Int. Cl. F21V 7/04

(52) U.S. Cl. 362/565; 362/551; 362/554; 362/566

(57) ABSTRACT

The present invention discloses a rotary structure that comprises a base and a hood, and the hood includes a multicolored pervious board surrounding the hood, and the multicolored pervious board includes a plurality of different shaped color areas, and the base includes a driver and a light emitting member, and the driver can drive the hood to rotate on the base, and the light emitting member can project its light source onto the multicolored pervious board. Therefore, when the driver drives the hood, the light emitting member projects its light source to each color area, so that the multicolored pervious board projects lights of different colors, and the way of installing the light emitting member can be changed to reduce the overall volume of the rotary structure.

### FIELD OF THE INVENTION

The present invention relates to a rotary structure, and more particularly to a rotary structure comprising a hood surrounded by a multicolored pervious board and pivotally coupled to a base thereof, enabling a light emitting member to project its light source onto the multicolored pervious board producing lights of different colors and thus reducing the overall volume of the rotary structure.

### BACKGROUND OF THE INVENTION

As science and technology advance and inspires innovations, some ceramics manufacturers integrate various different sound and light technologies to produce attractive stylish products, such as using optical fibers to propagate light waves and produce a light emitting flower, character, animal, or monster, etc. An end of each optical fiber is extended to an appropriate position on each of the stylish objects, and the other end of the optical fiber is tied and extended to the bottom of the stylish object, such that if the light wave of a light source at the bottom of the stylish object is projected onto the optical fibers, the light waves can be transmitted to each corner of the stylish object to give an amazing light effect to the stylish object.

As times change, people pay more attentions to their personal taste and style, and thus the artistic look or stylish design of many artworks or decorative objects becomes more important. However, many stylish designs are still very simple and dull and lack of artistic taste. For example, there is a common light emitting product as shown in FIG. 1, and the light emitting product includes a lamp stand 7 and a decorative section 9 (including the optical fiber). The lamp stand 7 includes an erect light bulb 71, a color film 72, and a rotary motor 73. The color film 72 is installed at an internal side of the lamp stand 7 and facing the light emitting end of the light bulb 71. A bearing 74 of the rotary motor 73 is pivotally coupled to the center of the color film 72. The decorative section 9 is disposed at another end of the color film 72 and facing the light bulb 71. When the rotary motor 73 drives the color film 72 to start rotating, the light source of the light bulb 71 is projected onto the decorative section 9 through the color film, such that the decorative section 9 can show different colors.

However, the lamp stand 7 of the light emitting stylish product usually contains at least one erect light bulb 71, a color film 72, and a rotary motor 73. Even though the thickness of the color film 72 and the rotary motor 73 occupied in the lamp stand 7 can be improved or reduced, the height of the erect light bulb 71 cannot improve the thickness occupied by the lamp stand 7. Therefore, the volume of the light emitting stylish product is quite large, and such issue cannot be improved effectively. Therefore, the light emitting stylish products are generally designed with a larger size and cannot be designed as an exquisite and compact design. Furthermore, the competition of the present souvenir market is very severe, major souvenir or artwork manufacturers will be eliminated if they are unable to catch up with the trend of the artistic look and stylish design of the products.

Due to the height of the erect light bulb in these light emitting stylish products, the thickness of the lamp stand of these products cannot be improved effectively, and the overall volume of the light emitting stylish cannot be reduced effectively. The foregoing shortcomings cannot be overcome, and the manufacturing cost cannot be lowered. Thus, the prior art demands immediate attentions and improvements.

### SUMMARY OF THE INVENTION

In view of the foregoing shortcomings of the prior art, the inventor of the present invention based on years on experience to conduct extensive researches and experiments and finally invented a rotary structure in accordance with the present invention.

Therefore, it is a primary objective of the present invention to provide a rotary structure that comprises a base and a hood, and the hood includes a multicolored pervious board surrounding the hood, and the multicolored pervious board includes a plurality of different shaped color areas, and the base includes a driver and a light emitting member, and the driver can drive the hood to rotate on the base, and the light emitting member can project its light source onto the multicolored pervious board. Therefore, when the driver drives the hood, the light emitting member projects its light source onto each color area, so that the multicolored pervious board projects lights of different colors, and the way of arranging the light emitting member can be changed to improve the volume of the rotary structure.

Another objective of the present invention is to use a light bulb as the light emitting member, and light bulb is covered by an oval lampshade, and the external look of the lampshade can reduce the thickness when the light bulb is installed transversally. Since the light bulb faces the multicolored pervious board, the thickness of the base is much smaller than the thickness of the erect light bulb. Thus, the volume of the present invention can be improved to save the material cost.

A further objective of the present invention is to install a protruded axle disposed at the base and facing a side of the hood, and the protruded axle is pivotally coupled with the hood, and the rotary structure includes a speed change mechanism disposed between the hood and the driver, and the speed change mechanism can adjust the rotary speed of the hood driven by the driver. The speed change mechanism includes a first gear and a second gear, and the first gear is installed at one side of the protruded axle and faces the center of the hood and coupled with an end of the protruded axle, and the second gear is installed at a side of the driver and faces the hood, and the second gear is engaged with the first gear for their operations, so that the driver can drive the hood to rotate on the base.

Another further objective of the present invention is to install a plurality of vents on the board member of the hood, and at least one side of each vent is aslant, such that when the driver drives the hood to rotate, the hood drives the hot air to rise and leave the hood from each lateral side, so as to achieve the heat dissipating effect.

The above and other objects, features and advantages of the present invention will become apparent from the following detailed description taken with the accompanying drawings.

### BRIEF DESCRIPTION OF THE DRAWINGS

FIG. 1 is a schematic view of a prior art structure;

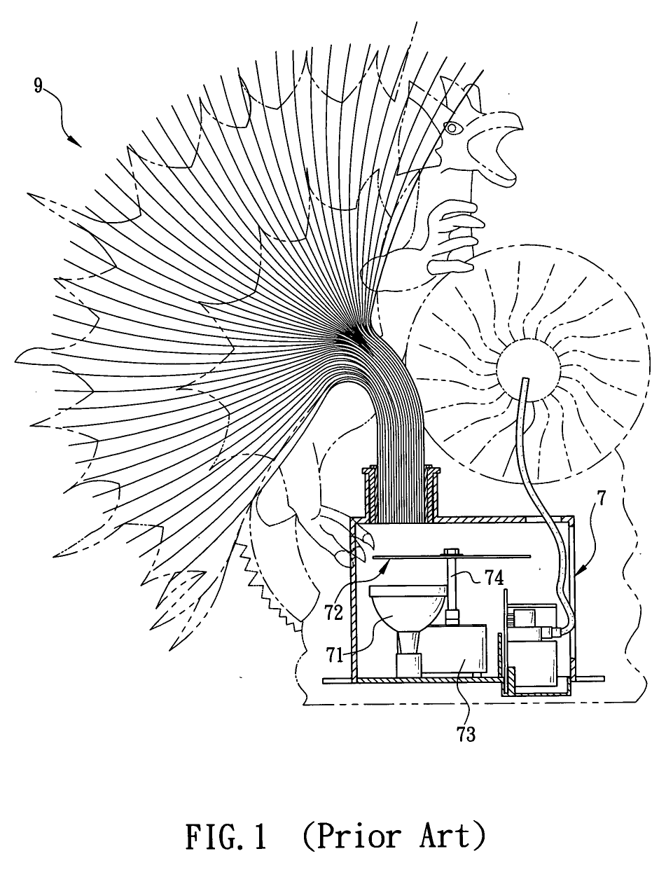

FIG. 2 is a schematic view of a structure of the invention;

FIG. 3 is an exploded view of a structure of the invention; and

FIG. 4 is a side view of a structure of the invention.

### DETAILED DESCRIPTION OF THE PREFERRED EMBODIMENTS

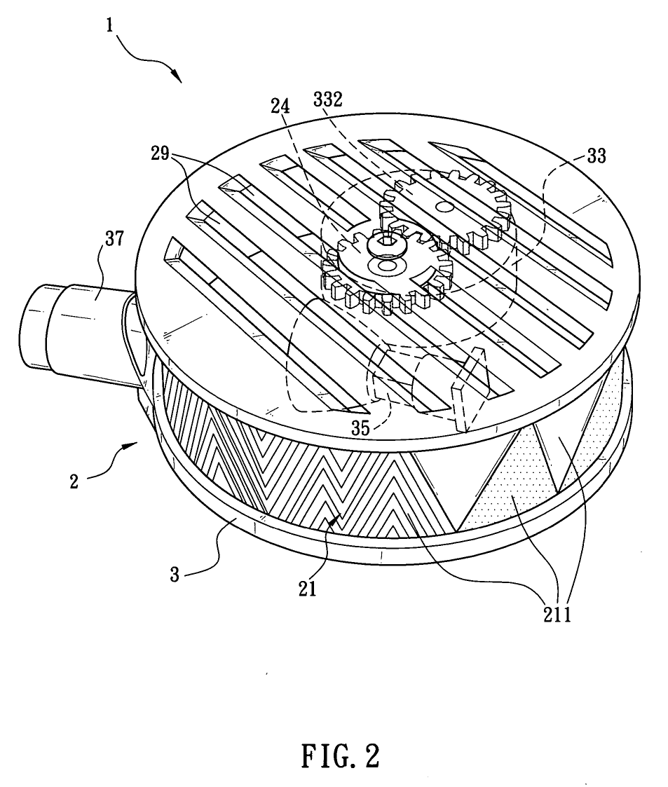

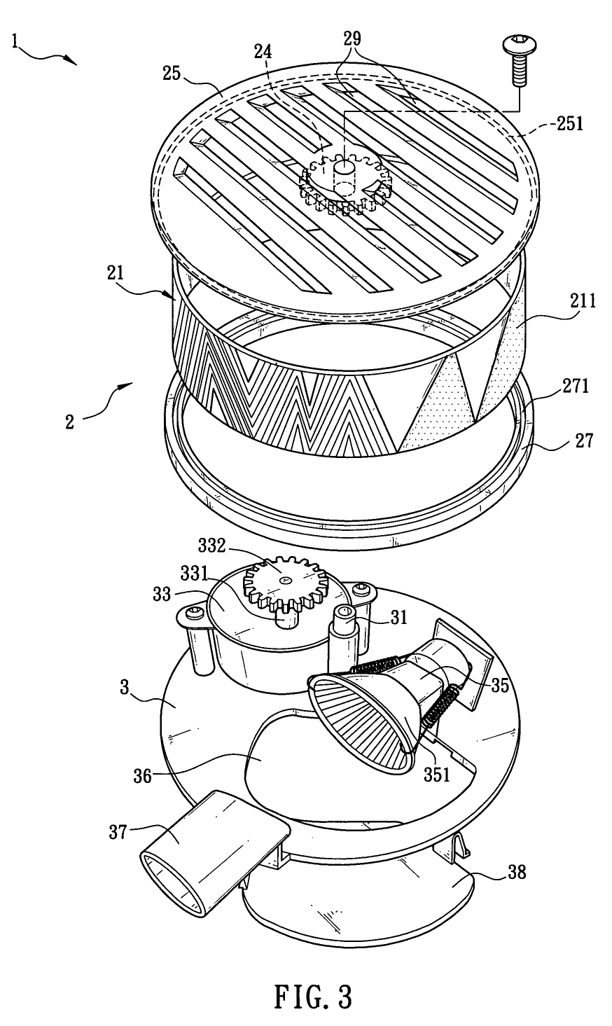

Referring to FIGS. 2 and 3, a rotary structure of the present invention comprises a base 3 and a hood 2, and the hood 2 is surrounded by a multicolored pervious board 21, and the multicolored pervious board 21 includes a plurality of different shaped color areas 211, and the base 3 includes a driver 33 and a light emitting member 35, and the driver 33 can drive the hood 2 to rotate on the base 3, and the light emitting member 35 can project a light source onto the multicolored pervious board 21. If the driver 33 drives the hood 2, the light emitting member 35 projects a light source onto each color area 211, such that the multicolored pervious board 21 projects a light source of different colors. The arrangement of the light emitting member 35 can be changed to improve the volume of the rotary structure 1 and reduce the overall volume for transportations as well as lowering its transportation cost.

Referring to FIGS. 2 and 3, the hood 2 of the present invention includes a board member 25 and a ring 27, and the board member 25 is installed at a side of the base 3 and at a position away from the hood 2, and the board member 25 includes a first groove 251 facing the base 3, and the ring 27 is installed at a side of the hood 2 and proximate to the base 3, and the ring 27 includes a second groove 271 around the ring 27 and facing the board member 25 and corresponding to both ends of the multicolored pervious board 21 and separately contained into the first and second grooves 251, 271, and the multicolored pervious board 21 surrounds the board member 25 and the ring 27 to form the hood 2.

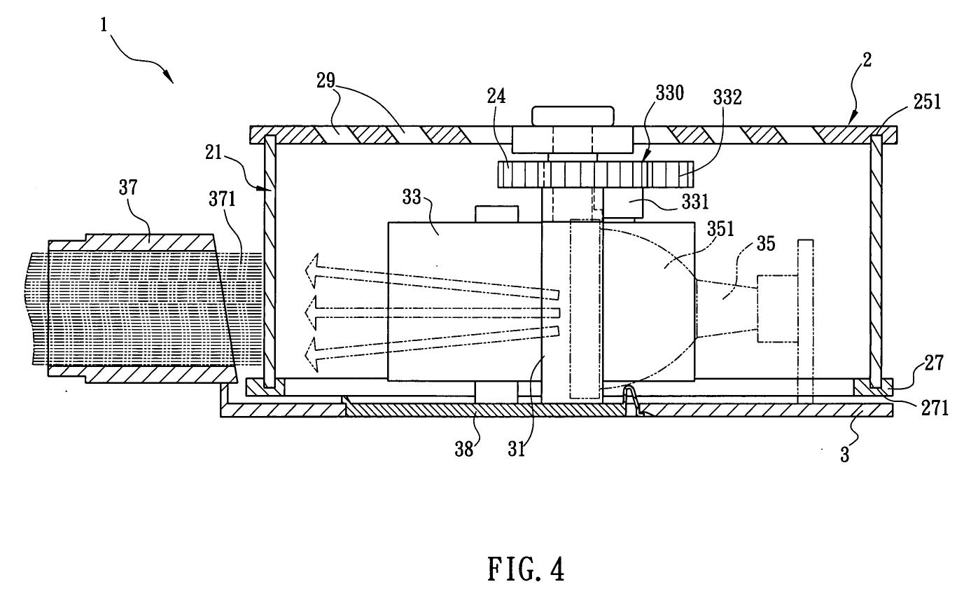

Referring to FIGS. 3 and 4, the base 3 of the present invention includes at least one support stand 37 at its periphery facing the light projecting direction of the light emitting member 35, and each support stand 37 is provided for placing an optical fiber bundle 371, and an end of the optical fiber bundle 371 receives a light of different colors emitted by the light emitting member 35 through the multicolored pervious board 21, and the light is transmitted to another end of the optical fiber bundle 371.

In a prior art erect light bulb of a light emitting stylish product, it is unable to improve or reduce the thickness and volume of the light emitting stylish product, and thus a preferred embodiment of the present invention as shown in FIGS. 2 and 3 uses a light bulb as the light emitting member 35, and the light bulb is covered by an oval lampshade 351, and the appearance of the lampshade 351 reduces the thickness of the transversally installed light bulb. Since the light emitting direction of the light bulb faces the multicolored pervious board 21 and the thickness of the base 3 is much smaller than the thickness of the prior art light bulb, therefore the hood 2 will not occupy much volume which can reduce the thickness. The overall volume of the light emitting stylish product can be reduced and thus the material and transportation costs can be lowered.

If the driver 33 cannot be pivotally coupled to the center of the hood 2 due to the limitation of its arrangement or other factors and the driver 33 drives the hood 2 to rotate, then the hood 2 will rotate about the protruded axle and occupy a certain space. The base 3 according to a preferred embodiment of the present invention as shown in FIGS. 3 and 4 includes a protruded axle 31 disposed at a side of the base 3 and facing the hood 2, and the protruded axle 31 is pivotally coupled to the hood 2, such that the hood 2 can be movably rotated. The rotary structure 1 includes a speed change mechanism 330 disposed between the hood 2 and the driver 33, and the speed change mechanism 330 can adjust the rotary speed of the hood 2 driven by the driver 33. The speed change mechanism 330 includes a first gear 24 and a second gear 332, and the first gear 24 is disposed at the center of the hood 2 and facing the protruded axle 31 and coupled to an end of the protruded axle 31, and the second gear 332 is disposed at the driver 33 and facing a side of the hood 2. The second gear 332 is engaged with the first gear 24 for their operations, such that after the driver 33 is started and a bearing 331 of the driver 33 drives the second gear 332, the first gear 24 is driven to rotate the hood 2 on the base 3. Further, if the rotary speed of the driver 33 of the speed change mechanism 330 does not comply with the design, the rotary speed of the driver 33 will be adjusted. The speed change mechanism 330 can use the corresponding gear numbers between the first gear 24 and the second gear 332 to achieve the function of changing the rotary speed. For example, if it is necessary to reduce the rotary speed of the hood 2, the gears are changed such that the first gear 24 has less number of revolution than the second gear 332, so that the revolutions per minute (RPM) of the second gear 332 is larger than that of the first gear 24, and the speed change mechanism 330 has the feature of changing the RPM of the driver 33.

Referring to FIGS. 2 and 3, a high-temperature hot air is produced when the driver 33 and the light emitting member 35 are operated in the hood 2, and the hot air may damage the components in the hood 2 and on the base 3. Therefore, the hood 2 of the invention includes a plurality of vents 29 disposed on the board member 25, and at least one lateral side of the vent 29 is aslant. When the driver 33 drives the hood 2 to rotate, the hood 2 drives the hot air to rise and leave the hood 2 along each lateral side, so as to achieve the heat dissipating effect.

If the light emitting member 35 fails due to overheat or other factors, and the rotary structure 1 does not come with a design for replacing the light emitting member 35, then the rotary structure 1 will lose its light emitting function, and then it is necessary to take some time to disassemble the rotary structure 1. It will cause a great deal of inconvenience to users and also will lose customer's loyalty to buy the rotary structure 1 again. Referring to FIGS. 2 and 3, the base 3 of the invention includes an opening 36 disposed at a position facing the light emitting member 35, and the opening 36 is provided for replacing the light emitting member 35 without disassembling the rotary structure 1, and the base 3 has a cover 38 for movably covering the opening 36 to prevent dust or foreign matters from coming into the rotary structure 1.

Referring to FIGS. 2 and 4, the color areas 211 show at least one color and one shape, and each color or shape determines the color and the time for displaying the color of the light source projected from the light emitting member 35 onto the optical fiber bundle 371. For example, a color area 211 shows a large area of a red triangle and a green triangle, and when the multicolored pervious board 21 is rotated, the light emitting member 35 projects a light with a red triangular shape onto the optical fiber bundle 371. The larger the area of the red triangle, the longer is the time for the light emitting member 35 to project the light onto the color area 211. With this design, the optical fiber bundle 371 can show predetermined graphic patterns and colors.

While the invention herein disclosed has been described by means of specific embodiments, numerous modifications and variations could be made thereto by those skilled in the art without departing from the scope and spirit of the invention set forth in the claims.

What is claimed is:

1. A rotary structure, comprising:
a base;
a hood, surrounded by a multicolored pervious board and pivotally coupled to said base;
a driver, installed on said base for driving said hood to rotate; and
a light emitting member, installed on said base and facing said multicolored pervious board for projecting a light source.

2. The rotary structure of claim 1, wherein said hood further comprises:
a board member, installed at a side of said hood and away from said base, and having a first groove board member disposed at a position facing said base, and said first groove being capable of containing an end of said multicolored pervious board; and
a ring, disposed at a side of said hood and proximate to said base, and having a second groove disposed around said ring and facing said board member, and said second groove being capable of containing an end of said multicolored pervious board that is away from said board member.

3. The rotary structure of claim 1, wherein said base includes a protruded axle disposed at a side facing said hood and pivotally coupled to said hood.

4. The rotary structure of claim 3, further comprising a speed change mechanism disposed between said hood and said driver.

5. The rotary structure of claim 4, wherein said speed change mechanism comprises:
a first gear, disposed at the central position of said hood and facing a side of said protruded axle and coupled to a side of said protruded axle facing said hood; and
a second gear, disposed at said driver and facing a side of said hood, and said two gears are engaged with each other.

6. The rotary structure of claim 1, wherein said base includes at least one support stand disposed at the periphery facing the light projecting direction of said light emitting member.

7. The rotary structure of claim 6, wherein said each support stand is provided for placing an optical fiber bundle, and an end of said optical fiber bundle receives different color lights emitted from said light emitting member through said multicolored pervious board, and said color lights are transmitted to another end of said optical fiber bundle.

8. The rotary structure of claim 2, wherein said hood includes a plurality of vents disposed on said board member.

9. The rotary structure of claim 2, wherein said vent has at least one side being an aslant side.

10. The rotary structure of claim 7, wherein said light bulb includes an oval shaped lampshade.

11. The rotary structure of claim 2, wherein said base includes an opening disposed at a position facing said light emitting member.

12. The rotary structure of claim 11, wherein said base includes a cover for movably covering said opening.

13. The rotary structure of claim 1, wherein said color area shows at least one color.

14. The rotary structure of claim 1, wherein said color area shows at least one shape.
